(19) United States
(12) Patent Application Publication
(10) Pub. No.: US 2025/0104662 A1
(43) Pub. Date: Mar. 27, 2025

(54) METHOD FOR DETERMINING AN OVERDRIVE VALUE AND RELATED DISPLAY PANEL

(71) Applicant: Shenzhen China Star Optoelectronics Semiconductor Display Technology Co., Ltd., Shenzhen (CN)

(72) Inventor: Xintian SU, Shenzhen (CN)

(73) Assignee: Shenzhen China Star Optoelectronics Semiconductor Display Technology Co., Ltd., Shenzhen (CN)

(21) Appl. No.: 18/395,242

(22) Filed: Dec. 22, 2023

(30) Foreign Application Priority Data
Sep. 21, 2023 (CN) 202311231802.9

(51) Int. Cl. G09G 3/36

(52) U.S. Cl. CPC G09G 3/3607; G09G 2320/0666; G09G 2360/16

(57) ABSTRACT

A method for determining an overdrive value includes: obtaining each brightness corresponding to each gray scale in a full grayscale range, where the full grayscale range comprises an initial grayscale range, and the initial gray scale range is from a minimum initial gray value to a maximum initial gray value; determining a grayscale-to-brightness conversion variation curve corresponding to the initial grayscale range; obtaining a brightness of a first frame in the grayscale-to-brightness conversion variation curve; obtaining a target gray value corresponding to a brightness having a smallest difference from the brightness of the first frame according to a comparison result of the brightness of the first frame with each brightness, where a target gray scale range is from the minimum initial gray value to the target gray value; and determining that the overdrive value corresponding to the target grayscale range is the maximum initial gray scale.

### CROSS REFERENCE TO RELATED APPLICATION

This application claims the priority of Chinese Patent Application No. 202311231802.9, entitled “METHOD FOR DETERMINING AN OVERDRIVE VALUE AND RELATED DISPLAY PANEL”, filed on Sep. 21, 2023, the disclosure of which is incorporated herein by reference in its entirety.

### FIELD OF THE DISCOSURE

The present disclosure relates to a display technology, and more particularly, to a method for determining an overdrive value and a related display panel.

### BACKGROUND

Conventionally, the adjusting of overdrive (OD) function is mainly performed by measuring the response time (RT) curve through a response time instrument, and the engineer can confirm whether the corresponding RT curve is qualified by controlling a timing controller to input different overdrive values, so as to determine the required overdrive value. And then the engineer could collect the corresponding number of overdrive values into a corresponding table, which is so called an overdrive table.

However, in the overdrive adjusting process, multiple overdrive values in each overdrive table requires to be manually determined one by one, which leads to large manpower demands and low efficiencies.

### SUMMARY

One objective of an embodiment of the present disclosure is to provide a method for determining an overdrive value and a related display panel to alleviate the above issue that requires large manpower demands and has low efficiencies to determine overdrive values.

According to an embodiment of the present disclosure, a method for determining an overdrive value is disclosed. The method comprises: obtaining each brightness corresponding to each gray scale in a full grayscale range, where a set of each brightness is a full brightness range, the full grayscale range comprises an initial grayscale range, and the initial gray scale range is from a minimum initial gray value to a maximum initial gray value; determining a grayscale-to-brightness conversion variation curve corresponding to the initial grayscale range; obtaining a brightness of a first frame in the grayscale-to-brightness conversion variation curve; obtaining a target gray value corresponding to a brightness having a smallest difference from the brightness of the first frame according to a comparison result of the brightness of the first frame with each brightness in the full brightness range, where a target gray scale range is from the minimum initial gray value to the target gray value; and determining that the overdrive value corresponding to the target grayscale range is the maximum initial gray scale.

Optionally, the grayscale-to-brightness conversion variation curve comprises a plurality of sequentially-connected wave bands. Each wave band comprises a low point, and the step for obtaining the brightness of the first frame in the grayscale-to-brightness conversion variation curve comprises: determining a frame end time of each frame corresponding to the low point of each wave band; obtaining an end time of the first frame according to the end time of each frame; determining the brightness of the first frame as a brightness at the end time of the first frame in the grayscale-to-brightness conversion variation curve.

Optionally, the grayscale-to-brightness conversion variation curve comprises a plurality of sequentially-connected wave bands. Each wave band comprises a low point, and the step for obtaining the brightness of the first frame in the grayscale-to-brightness conversion variation curve comprises: determining an end time of a frame corresponding to the low point of the band; obtaining a frame start time according to a difference between the end time of the frame and a frame time; determining a start time of the first frame in the grayscale-to-brightness conversion variation curve; obtaining an end time of the first frame according to the start time of the first frame; and determining the brightness of the first frame as a brightness corresponding to the end time of the first frame in the grayscale-to-brightness conversion variation curve.

Optionally, the step of obtaining each brightness corresponding to each gray scale in the full grayscale range comprises: respectively setting the minimum initial gray value and the maximum initial gray value as m and n, wherein m is less than n; configuring m as one in the first grayscale set; configuring n as one in the second grayscale set, and the second grayscale set is different from the first grayscale set.

Optionally, the step of configuring m as one in the first grayscale set comprises: setting the first grayscale set as [G0, G8, G16, G24, G32 . . . . G255].

Optionally, the step of configuring n as one in the second grayscale set comprises: setting the second grayscale set as [G8, G12, G16, G20, G24 . . . . G255].

Optionally, the step of determining that the overdrive value corresponding to the target grayscale range is the maximum initial gray scale comprises: obtaining a plurality of target grayscale ranges that are different from each other under a same color display; obtaining an expected number of overdrive values according to the plurality of target grayscale ranges.

Optionally, the method further comprises: after the step of obtaining the expected number of overdrive values according to the plurality of target grayscale ranges, aggregating the expected number of overdrive values to form an overdrive table.

Optionally, the step of aggregating the expected number of overdrive values to form an overdrive table comprises: aggregating the expected number of overdrive values under a red color display to form a red overdrive table; aggregating the expected number of overdrive values under a green color display to form a green overdrive table; aggregating the expected number of overdrive values under a blue color display to form a blue overdrive table.

According to another embodiment of the present disclosure, a display panel is disclosed. The display panel includes a processor and a memory storing computer program instructions executable by the processor. The processor executes computer program instructions to perform operations comprising: obtaining each brightness corresponding to each gray scale in a full grayscale range, where a set of each brightness is a full brightness range, the full grayscale range comprises an initial grayscale range, and the initial gray scale range is from a minimum initial gray value to a maximum initial gray value; determining a grayscale-to-brightness conversion variation curve corresponding to the initial grayscale range; obtaining a brightness of a first frame in the grayscale-to-brightness conversion variation curve; obtaining a target gray value corresponding to a brightness having a smallest difference from the brightness of the first frame according to a comparison result of the brightness of the first frame with each brightness in the full brightness range, where a target gray scale range is from the minimum initial gray value to the target gray value; determining that the overdrive value corresponding to the target grayscale range is the maximum initial gray scale.

Optionally, the grayscale-to-brightness conversion variation curve comprises a plurality of sequentially-connected wave bands, wherein each wave band comprises a low point, and the operation for obtaining the brightness of the first frame in the grayscale-to-brightness conversion variation curve comprises: determining a frame end time of each frame corresponding to the low point of each wave band; obtaining an end time of the first frame according to the end time of each frame; and determining the brightness of the first frame as a brightness at the end time of the first frame in the grayscale-to-brightness conversion variation curve.

Optionally, the grayscale-to-brightness conversion variation curve comprises a plurality of sequentially-connected wave bands, wherein each wave band comprises a low point, and the operation for obtaining the brightness of the first frame in the grayscale-to-brightness conversion variation curve comprises: determining an end time of a frame corresponding to the low point of the band; obtaining a frame start time according to a difference between the end time of the frame and a frame time; determining a start time of the first frame in the grayscale-to-brightness conversion variation curve; obtaining an end time of the first frame according to the start time of the first frame; and determining the brightness of the first frame as a brightness corresponding to the end time of the first frame in the grayscale-to-brightness conversion variation curve.

Optionally, the operation of obtaining each brightness corresponding to each gray scale in the full grayscale range comprises: setting the minimum initial gray value and the maximum initial gray value as m and n, respectively, wherein m is less than n; configuring m as one in the first grayscale set; configuring n as one in the second grayscale set, and the second grayscale set is different from the first grayscale set.

Optionally, the operation of configuring m as one in the first grayscale set comprises: setting the first grayscale set as [G0, G8, G16, G24, G32 . . . . G255].

Optionally, the operation of configuring n as one in the second grayscale set comprises: setting the second grayscale set as [G8, G12, G16, G20, G24 . . . . G255].

Optionally, the operation of determining that the overdrive value corresponding to the target grayscale range is the maximum initial gray scale comprises: obtaining a plurality of target grayscale ranges that are different from each other under a same color display; and obtaining an expected number of overdrive values according to the plurality of target grayscale ranges.

Optionally, the operations further comprise: after the operation of obtaining the expected number of overdrive values according to the plurality of target grayscale ranges, aggregating the expected number of overdrive values to form an overdrive table.

Optionally, the operation of aggregating the expected number of overdrive values to form an overdrive table comprises: aggregating the expected number of overdrive values under a red color display to form a red overdrive table; aggregating the expected number of overdrive values under a green color display to form a green overdrive table; and aggregating the expected number of overdrive values under a blue color display to form a blue overdrive table.

The method and display panel for determining the over-driven value according to an embodiment of the present disclosure obtain each brightness corresponding to each gray scale in the full gray scale range, then determine the grayscale-to-brightness conversion variation curve corresponding to the initial grayscale range, then obtain the brightness of the first frame in the grayscale-to-brightness conversion variation curve, then obtain the target gray value corresponding to the brightness with the smallest brightness difference in the first frame according to the comparison results of the brightness of the first frame and each brightness in the full brightness range, and then determine that the over-driving value corresponding to the target grayscale range is the maximum initial gray value. This realizes the automatic determination of the over-driving value, which not only reduces the manpower demands but also improves the determination efficiency and accuracy of the over-driving value.

### BRIEF DESCRIPTION OF THE DRAWINGS

In order to more clearly illustrate the technical solution in the embodiment of the present disclosure, the following will be a brief introduction to the drawings required in the description of the embodiment. Obviously, the drawings described below are only some embodiments of the present disclosure, for those skilled in the art, without the premise of creative labor, may also obtain other drawings according to these drawings.

FIG. 1 is a diagram of the overdrive principle according to an embodiment of the present disclosure.

FIG. 2 is a diagram of the overdrive adjusting curve and the display effect according to an embodiment of the present disclosure.

FIG. 3 is a comparative schematic diagram showing the response time curves corresponding to different overdrive values according to an embodiment of the present disclosure.

FIG. 4 is a diagram of an overdrive table according to an embodiment of the present disclosure.

FIG. 5 is a diagram of a grayscale-to-brightness conversion variation curve according to an embodiment of the present disclosure.

FIG. 6 is another diagram of a grayscale-to-brightness conversion variation curve according to an embodiment of the present disclosure.

FIG. 7 is a flow chart of a method for determining the overdrive value according to an embodiment of the present disclosure.

FIG. 8 is a diagram of a relationship between the gray value and the brightness according to an embodiment of the present disclosure.

FIG. 9 illustrate a diagram of grayscale-to-brightness conversion variation curves of initial grayscales G0-G8 according to an embodiment of the present disclosure.

FIG. 10 illustrate a diagram of grayscale-to-brightness conversion variation curves of initial grayscales G0-G12 according to an embodiment of the present disclosure.

FIG. 11 illustrate a diagram of grayscale-to-brightness conversion variation curves of initial grayscales G0-G16 according to an embodiment of the present disclosure.

FIG. 12 illustrate a diagram of grayscale-to-brightness conversion variation curves of initial grayscales G0-G20 according to an embodiment of the present disclosure.

FIG. 13 illustrate a diagram of grayscale-to-brightness conversion variation curves of initial grayscales Gm-Gn according to an embodiment of the present disclosure.

### DETAILED DESCRIPTION OF PREFERRED EMBODIMENTS

To help a person skilled in the art better understand the solutions of the present disclosure, the following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present disclosure.

The following disclosure provides many different embodiments or examples to implement different structures of the present disclosure. In order to simplify the disclosure of the present disclosure, the components and settings of specific examples are described below. They are for example purposes only and are not intended to limit this application. Further, the present disclosure may repeat reference numbers and/or reference letters in different examples, such duplication is for the purpose of simplification and clarity, and does not by itself indicate the relationship between the various embodiments and/or settings discussed. Further, the present disclosure provides various examples of specific processes and materials, but those of ordinary skill in the art may be aware of the application of other processes and/or the use of other materials. The following are described in detail, it should be noted that the order of description of the following embodiments is not used as a qualification for the preferred order of embodiments.

Further, the terms “first”, “second” are for descriptive purposes only, and cannot be understood as indicating or implying relative importance or implicitly indicating the number of technical features indicated, thereby limiting the features of “first”, “second” may explicitly or implicitly include one or more of the features, in the description of the present invention, “plurality” means two or more, unless otherwise expressly and specifically limited.

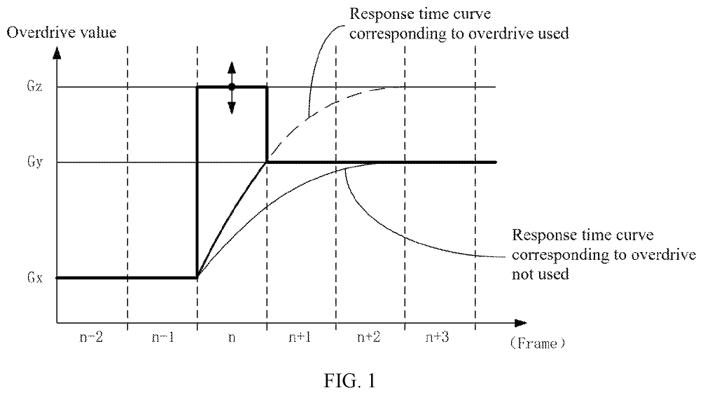

The overdrive principle is shown in FIG. 1, and the abscissa represents the frame (time), such as the (n−2)th frame, the (n−1)th frame, the nth frame, the (n+1)th frame, the (n+2)th frame, the (n+3)th frame . . . The ordinate represents the gray value. In order to speed up the response time (overdrive response), when the low gray value is transited to a high gray scale, an overdrive value larger than the desired gray scale is provided (conversely, a lower overdriven value is provided), so that the brightness could reach the target brightness faster.

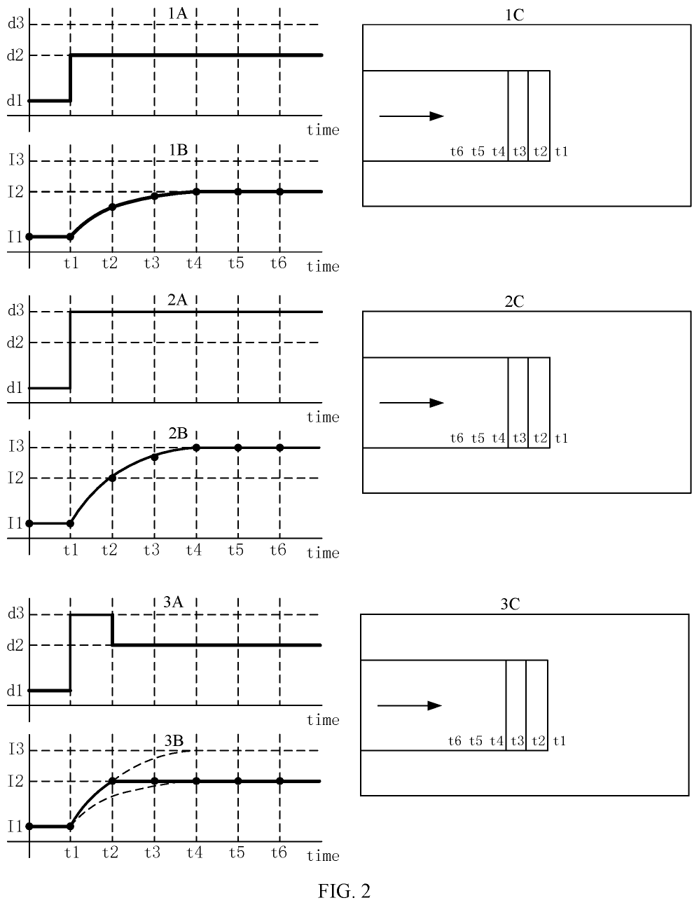

As shown in FIG. 2, the voltage level of the data signal of the image shown in FIG. 2 switches from d1 to d2 at the time t1. Correspondingly, the brightness shown in 1B in FIG. 2 begins to increase gradually from the time t1, and correspondingly, the image observed by the human eye is shown in 1C in FIG. 2, which gradually becomes brighter from the time t1.

The voltage level of the data signal of the image shown in 2A in FIG. 2 switches from d1 to d3 at the time t1. Correspondingly, the brightness shown in 2B in FIG. 2 begins to gradually increase from the time t1, and correspondingly, the image observed by the human eye is shown in 2C, which becomes brighter from the time t1 and is brighter than that shown in 1C.

The voltage of the data signal of the image shown in 3A in FIG. 2 switches from d1 to d3 at the time t1 and switches to d2 at the time t2. Correspondingly, the brightness shown in 3B in FIG. 2 begins to increase from the time t1 and remains unchanged since the time t2, and correspondingly, the image observed by the human eye is shown in 3C of FIG. 2, which is black at the time t1 becomes gray at the time t2 and after.

Therefore, from the above, it can be understood that the goal of overdrive is to reach the brightness of the target gray value within 1 frame.

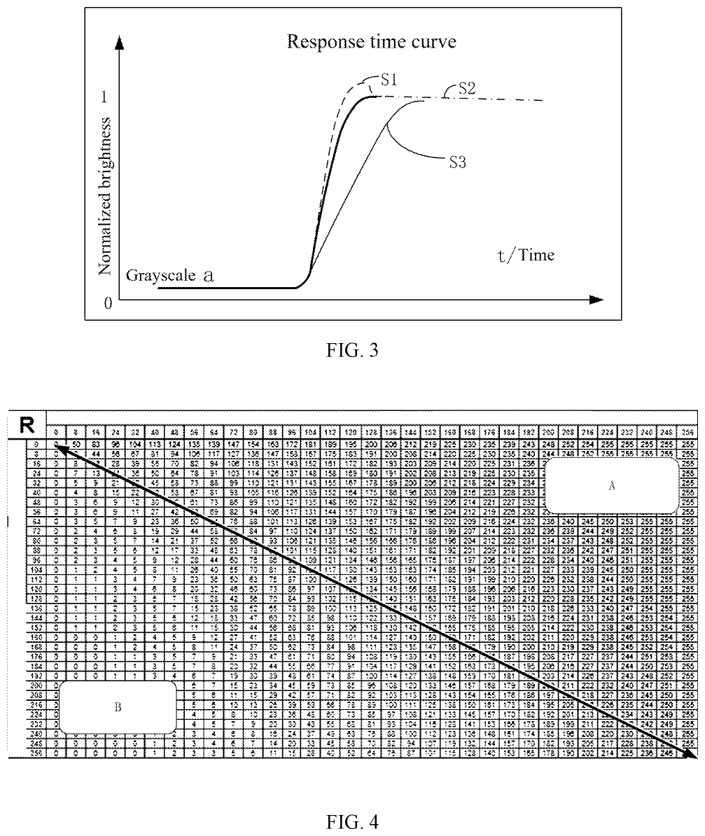

As shown in FIG. 3, the curve S1 indicates that the intensity of the overdrive adjustment is too strong. That is, the overdrive value is too large. The curve S3 indicates that the intensity of the overdrive adjustment is too weak. That is, the overdrive value is too low. The curve S2 indicates that the intensity of the overdrive adjustment meets the requirements. That is, the overdrive value is appropriate.

FIG. 4 shows the overdrive table used in the red display. The overdrive table includes 33*33 overdrive values. The overdrive values shown in zone A are used to adjust the display when the gray value is switched from a low value to a high value. The overdrive values shown in zone B are used to adjust the display when the gray value is switched from a high value to a low value. There are also overdrive tables used in the green display and in the blue display but are not shown for simplicity.

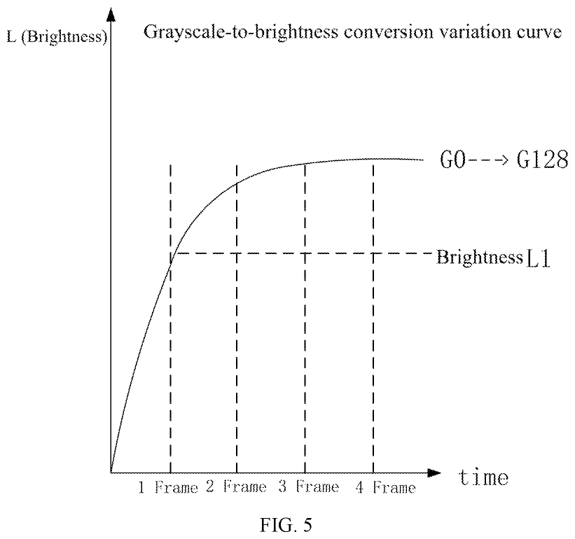

From the above, it can be seen that: as long as the brightness of the first frame in the grayscale-to-brightness conversion variation curve is obtained and compared with each brightness corresponding to each gray value, a gray value corresponding to the brightness with the smallest brightness difference in the first frame can be obtained. This gray value could be used as an overdrive value, as shown in FIG. 5.

FIG. 5 shows the grayscale-to-brightness conversion variation curve of the initial grayscale range of the gray values 0-128 (G0-G128). The abscissa is time (time) or frame (Frame), and the ordinate is brightness (L). From the grayscale-to-brightness conversion variation curve, the brightness of the first frame can be obtained as L1. L1 is then compared with each brightness. Assuming that the brightness with the least difference after comparison corresponds to the gray value 48 (G48), the overdrive value of the initial grayscale range (G0-G128) can be determined as G128.

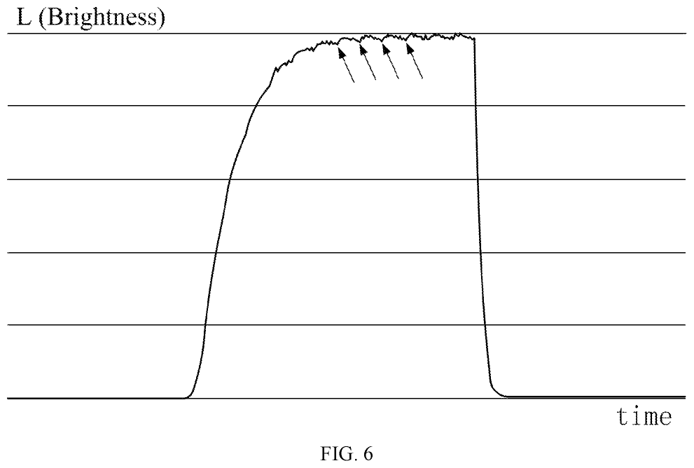

As shown in FIG. 6, the grayscale-to-brightness conversion variation curve comprises a plurality of end-to-end connected wavebands. Each waveband comprises a low point. The steps to obtain the brightness of the first frame in the grayscale-to-brightness conversion variation curve include: determining a frame end time of each frame corresponding to the low point of each waveband; obtaining an end time of the first frame according to the end time of each frame; and determining the brightness of the first frame as a brightness at the end time of the first frame in the grayscale-to-brightness conversion variation curve.

It is noted that each waveband represents a frame, and the low point of the waveband represents the end time of the frame. Therefore, the end time of each frame can be calculated according to the position of the arrow, and the brightness of the first frame could be determined according to the intersection of the end time of the first frame from left to right and the grayscale-to-brightness conversion variation curve.

In another embodiment, as shown in FIG. 6, the step of obtaining the brightness of the first frame in the grayscale-to-brightness conversion variation curve comprises: determining an end time of a frame corresponding to the low point of the band; obtaining a frame start time according to a difference between the end time of the frame and a frame time; determining a start time of the first frame in the grayscale-to-brightness conversion variation curve; obtaining an end time of the first frame according to the start time of the first frame; and determining the brightness of the first frame as a brightness corresponding to the end time of the first frame in the grayscale-to-brightness conversion variation curve.

It is noted that the frame time is the length of a frame, which is fixed or predictable. In this embodiment, the brightness of the first frame in the grayscale-to-brightness conversion variation curve could be obtained.

From the above, a method for automatically determining the overdrive value as detailed below could be obtained.

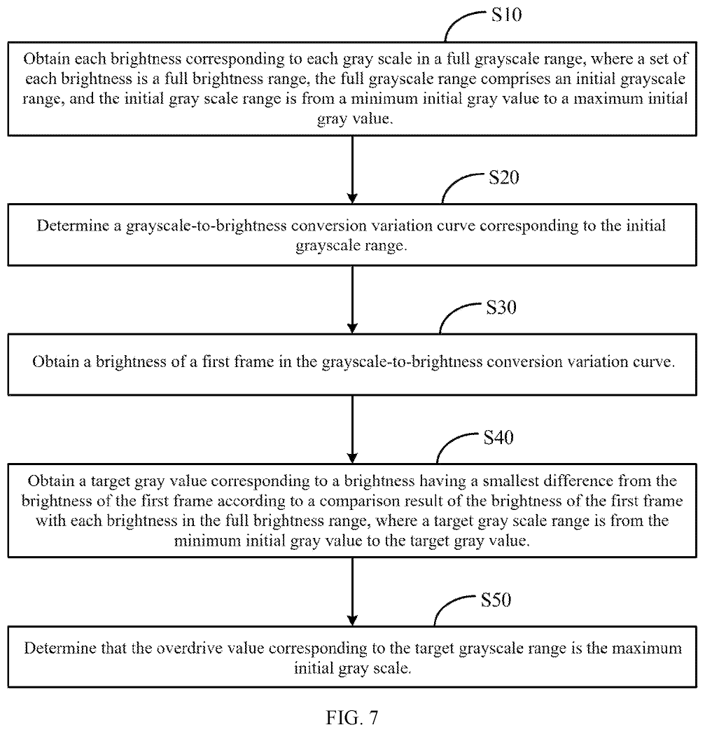

In view of the above-mentioned technical issue that that requires large manpower demands and has low efficiencies to determine overdrive values, a method for determining an overdrive value, as shown in FIG. 7 is disclosed according to an embodiment of the present disclosure. The method for determining an overdrive value comprises steps S10, S20, S30, S40 and S50.

At step S10, each brightness corresponding to each gray scale in a full grayscale range is obtained. A set of each brightness is a full brightness range, the full grayscale range comprises an initial grayscale range, and the initial gray scale range is from a minimum initial gray value to a maximum initial gray value.

At step S20: a grayscale-to-brightness conversion variation curve corresponding to the initial grayscale range is determined.

At step S30: a brightness of a first frame in the grayscale-to-brightness conversion variation curve is obtained.

At step S40: a target gray value corresponding to a brightness having a smallest difference from the brightness of the first frame is obtained according to a comparison result of the brightness of the first frame with each brightness in the full brightness range, where a target gray scale range is from the minimum initial gray value to the target gray value.

At step S50: determine that the overdrive value corresponding to the target grayscale range is the maximum initial gray scale.

It is noted that in this embodiment, the method obtains each brightness corresponding to each gray scale in the full gray scale range, then determines the grayscale-to-brightness conversion variation curve corresponding to the initial gray scale range, then obtains the brightness of the first frame in the first frame, then obtains the target gray scale corresponding to the brightness with the smallest brightness difference in the first frame according to the comparison results of the brightness of the first frame and each brightness in the full brightness range, and then determines that the overdrive value corresponding to the target gray scale range is the maximum initial gray scale. This realizes the automatic determination of the overdriven value. This not only reduces the manpower demands but also improves the determination efficiency and accuracy of the overdrive value.

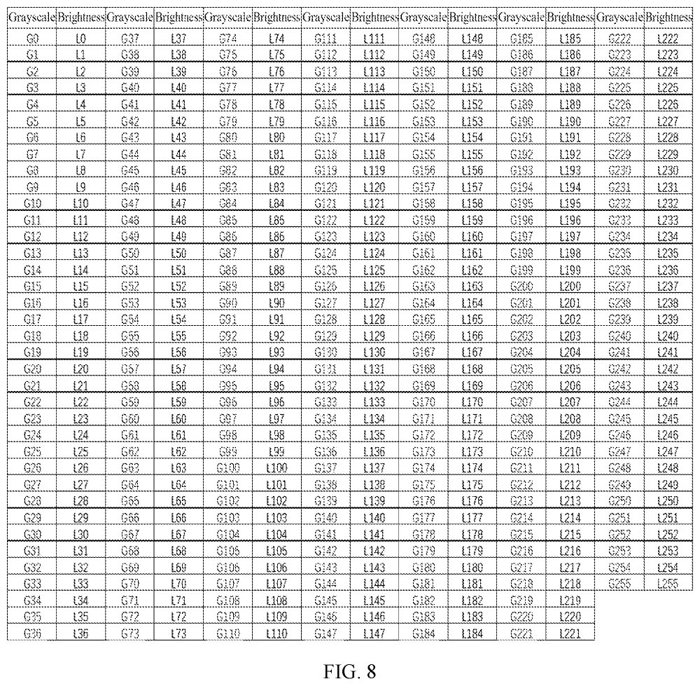

It is noted that the brightness corresponding to each gray scale in the full gray scale range can be obtained by the response time measuring instrument. For example, as shown in FIG. 8, the brightness L0-L255 correspond to the gray values G0-G255.

Then, the corresponding initial grayscale range (Gm-Gn) is determined from the full grayscale range (G0-G255), and the grayscale-to-brightness conversion variation curve corresponding to the initial grayscale range (Gm-Gn) is determined.

Here, m and n are the minimum and maximum initial gray values in the initial gray scale range, respectively, and m is less than n. Different m can be combined as a first gray value set, such as [G0, G8, G16, G24, G32 . . . G255]. Different n can be combined as a second gray value, such as [G8, G12, G16, G20, G24 . . . G255].

From this, a number of different grayscale-to-brightness conversion variation curves can be obtained, such as the product of the number of m in the first gray value set and the number of n in the second gray value set. Each grayscale-to-brightness conversion variation curve can determine a brightness of the first frame, denoted as Lm_n. And then the Lm_n is compared with L0-L255 to obtain the gray value Gx_m_n corresponding to the brightness with the smallest difference in Lm_n, where x can be 0, 1, 2 . . . 255. The overdrive value of the initial grayscale range (Gm-Gx_m_n) can be determined to be Gn.

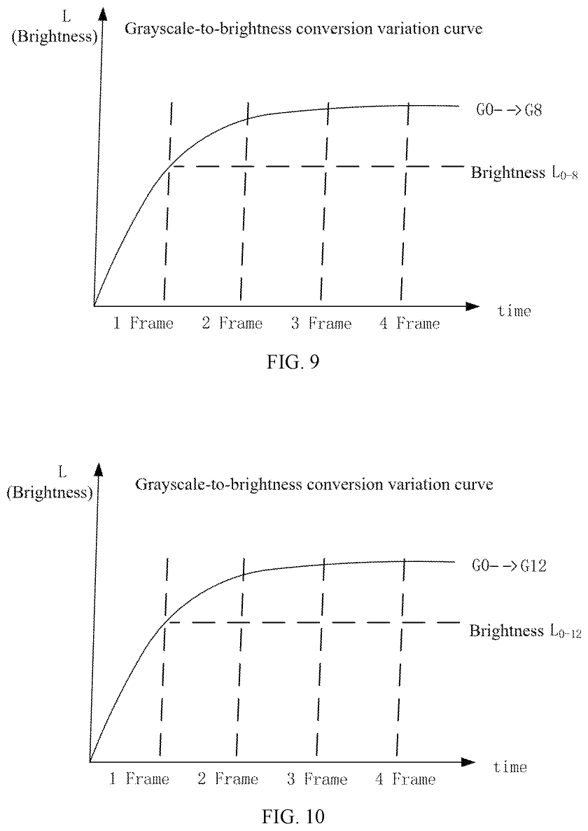

For example, if m is G0 and n is G8, as shown in FIG. 9, the grayscale-to-brightness conversion variation curve corresponding to G0-G8 can be obtained, and the brightness of the first frame in the grayscale-to-brightness conversion variation curve is L0-8.

If m is G0 and n is G12, as shown in FIG. 10, the grayscale-to-brightness conversion variation curve corresponding to G0-G12 can be obtained, and the brightness of the first frame in the grayscale-to-brightness conversion variation curve is L0-12.

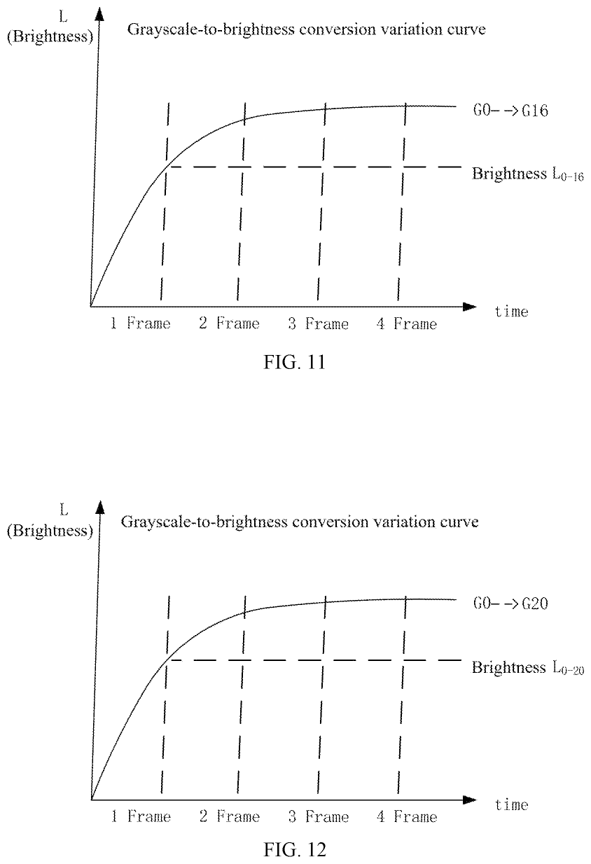

If m is G0 and n is G16, as shown in FIG. 11, the grayscale-to-brightness conversion variation curve corresponding to G0-G16 can be obtained, and the brightness of the first frame in the grayscale-to-brightness conversion variation curve is L0-16.

If m is G0 and n is G20, as shown in FIG. 12, the grayscale-to-brightness conversion variation curve corresponding to G0-G20 can be obtained, and the brightness of the first frame in the grayscale-to-brightness conversion variation curve is L0-20.

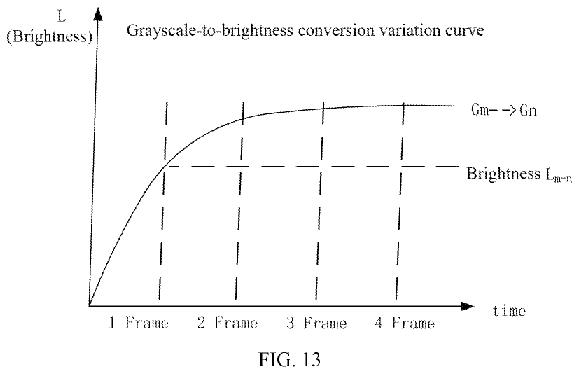

Similarly, as shown in FIG. 13, the grayscale-to-brightness conversion variation curve corresponding to Gm-Gn can be obtained, and the brightness of the first frame in the grayscale-to-brightness conversion variation curve is Lm-n.

In another embodiment, multiple different target grayscale ranges under the same color display are obtained. Each target grayscale range has a corresponding overdrive value, and the expected number of overdrive values according to the target grayscale range could be obtained.

It is noted that the expected number could be 33×33, or it can be adjusted according to the actual needs.

These overdrive values under the same color display could be aggregated as an overdrive table. Specifically, the expected number of overdrive values in the red display could be gathered as a red overdrive table, the expected number of overdrive values in the green display could be gathered as a green overdrive table, and the expected number of overdrive values in the blue display could be gathered as a blue overdrive table.

It is noted that the use of different overdrive meters under different color displays can accurately improve the response time of the liquid crystal for different color displays.

According to an embodiment of the present disclosure, a display panel is disclosed. The display panel performs a method for determining an overdrive value in any of the above-mentioned embodiments.

Since the display panel performs a method for determining an overdrive value in any of the above-mentioned embodiments, the display panel could also obtain each brightness corresponding to each gray scale in the full gray scale range, then determine the grayscale-to-brightness conversion variation curve corresponding to the initial grayscale range, then obtain the brightness of the first frame in the grayscale-to-brightness conversion variation curve, then obtain the target gray value corresponding to the brightness with the smallest brightness difference in the first frame according to the comparison results of the brightness of the first frame and each brightness in the full brightness range, and then determine that the over-driving value corresponding to the target grayscale range is the maximum initial gray value. This realizes the automatic determination of the over-driving value, which not only reduces the manpower demands but also improves the determination efficiency and accuracy of the over-driving value.

The display panel further comprises a memory and a processor. The memory stores computer program instructions that can be executed by the processor. The memory includes an ROM, an RAM, a disk, or an optical disk, which can store computer program instructions. Here, the computer program instructions or t computer program codes can be obtained by logical compiling the above-mentioned method of determining the overdrive value.

In addition, the display panel can be an LCD panel, or it can be a smart watch, a smart bracelet, a mobile phone, a tablet, a laptop and any other product or component with a display function.

In the above embodiments, the description of each embodiment has its own emphasis, and the part not described in detail in one embodiment may be referred to the relevant description of other embodiments.

The method for determining an overdrive value and the related display panel provided in the above embodiments of the present disclosure provided are introduced in detail, the principle and embodiment of the present disclosure is elaborated in the present disclosure by specific examples. The description of the above embodiments is only used to help understand the technical solution of the present disclosure and its core idea. At the same time, for those skilled in the art, according to the idea of the present disclosure, there will be changes in the specific embodiment and the scope of application, in summary, the content of this specification should not be understood as a restriction on the present disclosure.

1. A method for determining an overdrive value, the method comprising:
obtaining each brightness corresponding to each gray scale in a full grayscale range, wherein a set of each brightness is a full brightness range, the full grayscale range comprises an initial grayscale range, and the initial gray scale range is from a minimum initial gray value to a maximum initial gray value;
determining a grayscale-to-brightness conversion variation curve corresponding to the initial grayscale range;
obtaining a brightness of a first frame in the grayscale-to-brightness conversion variation curve;
obtaining a target gray value corresponding to a brightness having a smallest difference from the brightness of the first frame according to a comparison result of the brightness of the first frame with each brightness in the full brightness range, wherein a target gray scale range is from the minimum initial gray value to the target gray value; and
determining that the overdrive value corresponding to the target grayscale range is the maximum initial gray scale.

2. The method of claim 1, wherein the grayscale-to-brightness conversion variation curve comprises a plurality of sequentially-connected wave bands, wherein each wave band comprises a low point, and the step for obtaining the brightness of the first frame in the grayscale-to-brightness conversion variation curve comprises:
determining a frame end time of each frame corresponding to the low point of each wave band;
obtaining an end time of the first frame according to the end time of each frame; and
determining the brightness of the first frame as a brightness at the end time of the first frame in the grayscale-to-brightness conversion variation curve.

3. The method of claim 1, wherein the grayscale-to-brightness conversion variation curve comprises a plurality of sequentially-connected wave bands, wherein each wave band comprises a low point, and the step for obtaining the brightness of the first frame in the grayscale-to-brightness conversion variation curve comprises:
determining an end time of a frame corresponding to the low point of the band;
obtaining a frame start time according to a difference between the end time of the frame and a frame time;
determining a start time of the first frame in the grayscale-to-brightness conversion variation curve;
obtaining an end time of the first frame according to the start time of the first frame; and
determining the brightness of the first frame as a brightness corresponding to the end time of the first frame in the grayscale-to-brightness conversion variation curve.

4. The method of claim 1, wherein the step of obtaining each brightness corresponding to each gray scale in the full grayscale range comprises:
respectively setting the minimum initial gray value and the maximum initial gray value as m and n, wherein m is less than n;
configuring m as one in the first grayscale set;
configuring n as one in the second grayscale set, and the second grayscale set is different from the first grayscale set.

5. The method of claim 4, wherein the step of configuring m as one in the first grayscale set comprises:
setting the first grayscale set as [G0, G8, G16, G24, G32 . . . G255].

6. The method of claim 5, wherein the step of configuring n as one in the second grayscale set comprises:
setting the second grayscale set as [G8, G12, G16, G20, G24 . . . G255].

7. The method of claim 1, wherein the step of determining that the overdrive value corresponding to the target grayscale range is the maximum initial gray scale comprises:
obtaining a plurality of target grayscale ranges that are different from each other under a same color display; and
obtaining an expected number of overdrive values according to the plurality of target grayscale ranges.

8. The method of claim 7, further comprising:
after the step of obtaining the expected number of overdrive values according to the plurality of target grayscale ranges, aggregating the expected number of overdrive values to form an overdrive table.

9. The method of claim 8, wherein the step of aggregating the expected number of overdrive values to form an overdrive table comprises:
aggregating the expected number of overdrive values under a red color display to form a red overdrive table;
aggregating the expected number of overdrive values under a green color display to form a green overdrive table; and
aggregating the expected number of overdrive values under a blue color display to form a blue overdrive table.

10. A display panel, comprising:
a processor; and
a memory, storing non-transitory computer program instructions executable by the processor to perform operations comprising:
obtaining each brightness corresponding to each gray scale in a full grayscale range, wherein a set of each brightness is a full brightness range, the full grayscale range comprises an initial grayscale range, and the initial gray scale range is from a minimum initial gray value to a maximum initial gray value;
determining a grayscale-to-brightness conversion variation curve corresponding to the initial grayscale range;
obtaining a brightness of a first frame in the grayscale-to-brightness conversion variation curve;
obtaining a target gray value corresponding to a brightness having a smallest difference from the brightness of the first frame according to a comparison result of the brightness of the first frame with each brightness in the full brightness range, wherein a target gray scale range is from the minimum initial gray value to the target gray value; and
determining that the overdrive value corresponding to the target grayscale range is the maximum initial gray scale.

11. The display panel of claim 10, wherein the grayscale-to-brightness conversion variation curve comprises a plurality of sequentially-connected wave bands, each wave band comprises a low point, and the operation for obtaining the brightness of the first frame in the grayscale-to-brightness conversion variation curve comprises:
determining a frame end time of each frame corresponding to the low point of each wave band;
obtaining an end time of the first frame according to the end time of each frame; and
determining the brightness of the first frame as a brightness at the end time of the first frame in the grayscale-to-brightness conversion variation curve.

12. The display panel of claim 10, wherein the grayscale-to-brightness conversion variation curve comprises a plurality of sequentially-connected wave bands, each wave band comprises a low point, and the operation for obtaining the brightness of the first frame in the grayscale-to-brightness conversion variation curve comprises:
determining an end time of a frame corresponding to the low point of the band;
obtaining a frame start time according to a difference between the end time of the frame and a frame time;
determining a start time of the first frame in the grayscale-to-brightness conversion variation curve;
obtaining an end time of the first frame according to the start time of the first frame; and
determining the brightness of the first frame as a brightness corresponding to the end time of the first frame in the grayscale-to-brightness conversion variation curve.

13. The display panel of claim 10, wherein the operation of obtaining each brightness corresponding to each gray scale in the full grayscale range comprises:
respectively setting the minimum initial gray value and the maximum initial gray value as m and n, wherein m is less than n;
configuring m as one in the first grayscale set;
configuring n as one in the second grayscale set, and the second grayscale set is different from the first grayscale set.

14. The display panel of claim 13, wherein the operation of configuring m as one in the first grayscale set comprises:
setting the first grayscale set as [G0, G8, G16, G24, G32 . . . G255].

15. The display panel of claim 14, wherein the operation of configuring n as one in the second grayscale set comprises: setting the second grayscale set as [G8, G12, G16, G20, G24 . . . G255].

16. The display panel of claim 10, wherein the operation of determining that the overdrive value corresponding to the target grayscale range is the maximum initial gray scale comprises:
obtaining a plurality of target grayscale ranges that are different from each other under a same color display; and
obtaining an expected number of overdrive values according to the plurality of target grayscale ranges.

17. The display panel of claim 16, wherein the operations further comprise:
after the operation of obtaining the expected number of overdrive values according to the plurality of target grayscale ranges, aggregating the expected number of overdrive values to form an overdrive table.

18. The display panel of claim 17, wherein the operation of aggregating the expected number of overdrive values to form an overdrive table comprises:
aggregating the expected number of overdrive values under a red color display to form a red overdrive table;
aggregating the expected number of overdrive values under a green color display to form a green overdrive table; and
aggregating the expected number of overdrive values under a blue color display to form a blue overdrive table.
